(19) United States
(12) Patent Application Publication
(10) Pub. No.: US 2019/0317420 A1
(43) Pub. Date: Oct. 17, 2019

(54) CAPSULE TONER, TWO-COMPONENT DEVELOPER, IMAGE FORMING APPARATUS, AND METHOD FOR PRODUCING CAPSULE TONER

(71) Applicant: SHARP KABUSHIKI KAISHA, Sakai City (JP)

(72) Inventors: TAKESHI TSUKIYAMA, Sakai City (JP); KAZUYA KOREMATSU, Sakai City (JP); TAKASHI HARA, Sakai City (JP)

(21) Appl. No.: 16/378,101

(22) Filed: Apr. 8, 2019

(30) Foreign Application Priority Data
Apr. 12, 2018 (JP) 2018-076586
Feb. 7, 2019 (JP) 2019-020688

(51) Int. Cl. G03G 9/093; G03G 9/087

(52) U.S. Cl. CPC G03G 9/09307; G03G 9/08795; G03G 9/08797; G03G 9/09392

(57) ABSTRACT

A capsule toner includes core toner particles, and a coating layer that coats the core toner particles. The resin fine particles that form the coating layer have a weight-average molecular weight value within a range of Mw=100×1,000 to 450×1,000 measured by gel permeation chromatography (GPC).

### BACKGROUND

### 1. Field

The present disclosure relates to a capsule toner and a two-component developer, which are used in an electrophotographic image forming apparatus, and to an image forming apparatus and a method for producing a capsule toner.

### 2. Description of the Related Art

An image forming apparatus using an electrophotographic system forms images through. For example, charging, exposure, development, transfer, cleaning, static electricity removal, and fixing. In the image forming apparatus, the surface of a photoreceptor (electrostatic latent image holding member) rotationally driven is uniformly charged by a charging unit, and the charged surface of the photoreceptor is irradiated with a laser beam by an exposure device to form an electrostatic latent image on the surface of the photoreceptor. Next, the electrostatic latent image on the surface of the photoreceptor is developed by a developing device using a developer to form a toner image on the surface of the photoreceptor. Then, the toner image on the surface of the photoreceptor is transferred to a transfer material by a transfer device and then fixed on the transfer material by heating with a fixing device. Also, after the image forming operations, the transfer toner remaining on the surface of the photoreceptor is removed by a cleaning device and recovered in a predetermined recovery part. Then, the residual charge on the surface of the photoreceptor after cleaning is statically removed by an electricity removing device, making preparation for next image formation.

A method for achieving energy saving in the image forming apparatus includes low-temperature fixing using a toner containing a binder resin with a low softening point. The low-temperature fixing can suppress the electric power supplied to the fixing device. However, the toner containing a binder resin with a low softening point is easily fused by heat, degrading blocking resistance.

However, there is a method for improving the blocking resistance without degrading the low-temperature fixing properties of a toner, in which the surfaces of core toner particles containing a binder resin with a lower softening point than a predetermined softening point are modified by coating with a resin (coating layer) having a higher softening point than that of the core toner particles and higher heat resistance than a predetermined heat resistant temperature.

For example, Japanese Unexamined Patent Application Publication No. 2016-90965 discloses a capsule toner containing core toner particles which have surfaces coated with a shell layer containing a thermosetting component and in which the average circularity, the charge attenuation coefficient of the charge possessed by the surfaces, and the thickness of the shell layer are specified, thereby causing excellent heat-resistant storage properties, transfer properties, and cleaning properties.

A capsule toner is desired to be improved in low-temperature fixing properties and stress resistance in a developing tank in addition to storage stability and cleaning properties.

However, Japanese Unexamined Patent Application Publication No. 2016-90965 does not describe about the low-temperature fixing properties of the capsule toner and the stress resistance thereof in a developing tank.

It is desirable to provide a capsule toner which includes core toner particles and a coating layer, that coats the core toner particles, and which can be improved in low-temperature fixing properties and stress resistance in a developing tank in addition to storage stability and cleaning properties. It is also desirable to provide a two-component developer, an image forming apparatus, and a method for producing a capsule toner.

### SUMMARY

As a result of earnest research repeated by the inventors for addressing the problems described above, the following was found.

That is, when in a capsule toner including core toner particles and a coating layer, which coats the core toner particles, the resin fine particles forming the coating layer are adjusted to have a molecular weight within a predetermined range, storage stability and cleaning properties and further low-temperature fixing properties and stress resistance in a developing tank can be improved. For example, the resin fine particles forming the coating layer is hardened by increasing the molecular weight. Therefore, the surface of the capsule toner hardly deteriorates, and thus it is possible to effectively avoid the occurrence of fusion of the capsule toner on a developing roller (developer holding member) in a developing device. This allows the formed image to maintain high image quality through the life. In addition, the hard resin fine particles forming the coating layer (also referred to as the “shell layer”) can be improved in flowability. Therefore, in a method for producing the capsule toner, the temperature of treatment to form a film by mechanical treatment can be increased, and thus a thinner film hard to peel can be formed. Further, it is possible to decrease the occurrence of resin fine particles (referred to as the “residual shell”) not adhering as the coating layer to the surfaces of the core toner particles. Therefore, during fixing in an image forming apparatus, heat is easily transmitted, and thus the fixing properties can be improved.

The present disclosure is based on the finding described above and provides a capsule toner, a two-component developer, an image forming apparatus, and a method for producing a capsule toner described below.

### (1) Capsule Toner

According to an aspect of the present disclosure, there is provided a capsule toner including core toner particles and a coating layer which coats the core toner particles. The resin fine particles forming the coating layer have a weight-average molecular weight value within a range of Mw=100×1,000 to 450×1,000, according to measurement by gel permeation chromatography (GPC).

### (2) Two-Component Developer

According to another aspect of the present disclosure, there is provided a two-component developer including the capsule toner described above and a carrier.

### (3) Image Forming Apparatus

According to a further aspect of the present disclosure, there is provided an image forming apparatus using the two-component developer described above.

### (4) Method for Producing Capsule Toner

According to a still further aspect of the present disclosure, there is provided a method for producing a capsule toner which is a method for producing the capsule toner described above, the method including dispersing composite particles of the core toner particles and the resin fine particles forming the coating layer in an air flow circulating in an annular flow passage at a flow rate of 30 m/s or more, thereby producing the capsule toner by mechanical treatment in a rotary stirring part provided in the middle of the flow passage.

### BRIEF DESCRIPTION OF THE DRAWINGS

FIG. 1 is a conceptual diagram showing the sectional configuration of a capsule toner according to an embodiment of the present disclosure;

FIG. 2 is a process drawing showing a method for producing a capsule toner according to an embodiment of the present disclosure;

FIG. 3 is a front view showing the schematic configuration of a capsule toner producing apparatus used in a method for producing a capsule toner according to an embodiment of the present disclosure; and

FIG. 4 is a schematic sectional view of the producing apparatus shown in FIG. 3 as viewed along section line IV-IV.

### DESCRIPTION OF THE EMBODIMENTS

### 1. Capsule Toner

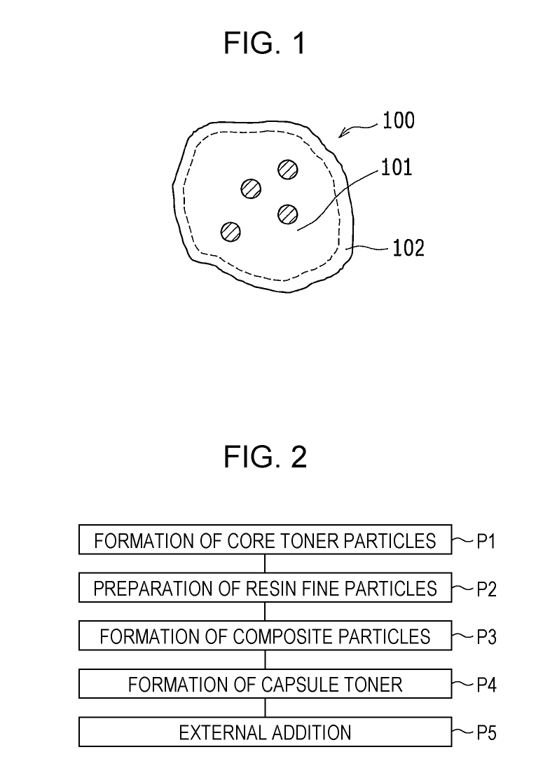

FIG. 1 is a conceptual diagram showing the sectional configuration of a capsule toner 100 according to an embodiment of the present disclosure. The capsule toner 100 according to the embodiment is formed of core toner particles 101 and a coating layer 102 (shell layer) formed outside the core toner particles 101 by using resin fine particles. The configuration of the capsule toner 100 is described in detail below.

### (Core Toner Particle)

The core toner particles 101 contain a binder resin, a coloring agent, a release agent. The binder resin is a base resin of the core toner particles 101. A styrene acrylic copolymer resin can be used as the binder resin. Examples of a monomer which can be used as a resin raw material include styrene derivative such as styrene, o-methylstyrene, m-methylstyrene, p-methylstyrene, α-methylstyrene, p-ethylstyrene, 2,4-dimethylstyrene, and the like; acrylic acid derivatives and methacrylic acid derivatives such as acrylic acid, methyl acrylate, ethyl acrylate, n-butyl acrylate, isobutyl acrylate, propyl acrylate, octyl acrylate, 2-chloroethyl acrylate, phenyl acrylate, methacrylic acid, methyl methacrylate, ethyl methacrylate, propyl methacrylate, n-butyl methacrylate, isobutyl methacrylate, n-octyl methacrylate, 2-ethylhexyl methacrylate, phenyl methacrylate, methacrylic acid dimethylaminoester, and the like.

Further usable examples of the resin raw material include vinyl monomers such as maleic anhydride, maleic acid monomethyl ester, maleic acid monoethyl ester, maleic acid monophenyl ester, maleic acid monoallyl ester, divinyl benzene, and the like.

The glass transition point of the binder resin is preferably 40° C. or more and 60° C. or less. The binder resin having a glass transition point of less than 40° C. easily causes blocking by thermal aggregation of capsule toner particles in an image forming apparatus, and thus storage stability may be decreased. The binder resin having a glass transition point exceeding 60° C. may degrade the low-temperature fixing properties.

Carbon black, an organic pigment, and the like, which are commonly used in the electrophotographic field, can be used as the coloring agent.

Usable examples of a black coloring agent include carbon black, copper oxide, manganese dioxide, aniline black, activated carbon, nonmagnetic ferrite, magnetic ferrite, magnetite, and the like.

Usable examples of a yellow coloring agent include C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180, C.I. Pigment Yellow 185, and the like.

Usable examples of a magenta coloring agent include C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, and the like.

Usable examples of a cyan coloring agent include C.I. Pigment Blue 15, C.I. Pigment Blue 15:2, C.I. Pigment Blue 15:3, C.I. Pigment Blue 16, C.I. Pigment Blue 60, and the like.

The amount of the coloring agent used is not particularly limited but is preferably 5 parts by weight or more and 10 parts by weight or less relative to 100 parts by weight of the binder resin. The coloring agent may be used as a master batch in order to uniformly disperse in the binder resin.

Usable examples of the release agent include paraffin wax, microcrystalline wax, Fischer-Tropsch wax, polyethylene wax, polypropylene wax, carnauba wax, synthetic ester wax, and the like. The amount of the release agent used is not particularly limited and can be properly selected from a wide range. The amount is preferably 2.0 parts by weight or more and 6.0 parts by weight or less relative to 100 parts by weight of the binder resin. When the amount of the release agent added is less than 2.0 parts by weight, the release agent hardly breeds out during fixing of the capsule toner 100, thereby easily causing high-temperature offset. When the amount of the release agent added is more than 6.0 parts by weight, the release agent is exposed from the surfaces of the core toner particles 101, and thus flowability of the core toner particle 101 may be worsened.

If required, a charge control agent may be added to the core toner particles 101. Charge control agents for positive charge control and for negative charge control, which are commonly used in this field, can be used as the charge control agent.

Usable examples of the charge control agent for positive charge control include quaternary ammonium salts, pyrimidine compounds, triphenylmethane derivatives, guanidine salts, amidine salts, and the like.

Usable examples of the charge control agent for negative charge control include metal-containing azo compounds, azo complex dyes, metal complexes and metal salts (metals are chromium, zinc, zirconium, and the like) of salicylic acid and its derivatives, organic bentonite compounds, boron compounds, and the like.

The amount of the charge control agent used is not particularly limited and can be properly selected from a wide range, but is preferably 0.5 parts by weight or more and 3 parts by weight or less relative to 100 parts by weight of the binder resin.

The volume-average particle diameter of the core toner particles 101 is preferably 4 m or more and 8 μm or less. With the volume-average particle diameter of 4 μm or more and 8 μm or less, an image with high definition can be stably formed over a long period of time. Also, when the particle diameter of the core toner particles 101 is decreased within the range, a high image density may be obtained even with a small deposition amount, and the effect of making it possible to decrease the toner consumption amount can be achieved. The core toner particles 101 having a volume-average particle diameter of less than 4 μm may cause higher charging and lower flowability due to the small particle diameter of the toner particles. With the higher charging and lower flowability of the toner, the toner may not be stably supplied to a photoreceptor, and thus surface fogging and a decrease in image density may occur. When the volume-average particle diameter of the core toner particles 101 exceeds 8 μm, the layer thickness of the formed image is increased due to the large particle diameter of the core toner particles 101, resulting in an image with remarkable graininess and failing to obtain a high-definition image. Also, an increase in the particle diameter of the core toner particles 101 decreases the specific surface area and decreases the toner charging amount. With the decreased charging amount of the toner, the toner may not be stably supplied to the photoreceptor, and thus contamination may occur in the apparatus due to toner scattering.

### (Coating Layer)

The coating layer 102 is formed outside the core toner particles 101 by using an acrylic resin. A resin produced by polymerizing or copolymerizing a single monomer or plural monomers containing at least an acrylic monomer or methacrylic monomer can be used as the acrylic resin.

Usable examples of the acrylic monomer include acrylic acid, methyl acrylate, ethyl acrylate, n-butyl acrylate, isobutyl acrylate, propyl acrylate, octyl acrylate, 2-chloroethyl acrylate, phenyl acrylate, and the like.

Usable examples of the methacrylic monomer include acrylic acid derivatives and methacrylic acid derivatives such as methacrylic acid, methyl methacrylate, ethyl methacrylate, propyl methacrylate, n-butyl methacrylate, isobutyl methacrylate, n-octyl methacrylate, 2-ethylhexyl methacrylate, phenyl methacrylate, methacrylic acid dimethylaminoester, and the like.

Usable examples of a monomer other than the acrylic monomer or methacrylic monomer include styrene derivatives such as styrene, o-methylstyrene, m-methylstyrene, p-methylstyrene, α-methylstyrene, p-ethylstyrene, 2,4-dimethylstyrene, and the like.

### 2. Method for Producing Capsule Toner

FIG. 2 is a process drawing showing a method for producing the capsule toner 100 according to an embodiment of the present disclosure. The method for producing the capsule toner 100 according to the embodiment includes (P1) forming the core toner particles 101, (P2) preparing resin fine particles which form the coating layer 102, (P3) forming composite particles by compounding the core toner particles 101 and the resin fine particles, (P4) forming capsule particles by forming the coating layer 102 on the surfaces of the core toner particles 101, and (P5) externally adding and mixing an external additive to and with the capsule toner particles.

### (1) Formation of Core Toner Particles (P1)

In formation of toner particles (P1), the core toner particles 101 are formed. Examples of a method for forming the core toner particles 101 include dry methods such as a kneading-grinding method and the like; wet methods such as a suspension-polymerization method, an emulsion-aggregation method, a dispersion-polymerization method, a dissolution-suspension method, a melt-emulsification method, and the like. The method for forming the core toner particles 101 by the kneading-grinding method is described below.

In forming the core toner particles 101 by the grinding method, core toner particle raw materials containing a binder resin, a coloring agent, and other additives are wet-mixed by a mixer and then melt-kneaded by a kneader to prepare a melt-kneaded product. The melt-kneaded product is cool-solidified, and the resultant solidified product is ground by a grinder to produce a finely ground product. Then, if required, the grain size is adjusted by classification, producing the core toner particles 101.

A known mixer can be used as the mixer, and examples thereof include a Henschel mixer (trade name, manufactured by NIPPON COKE & ENGINEERING CO., LTD.), Super mixer (trade name, manufactured by KAWATA MFG. CO., LTD.), and the like.

A known kneader can be used as the kneader, and examples thereof include two-shaft kneaders such as PCM-65/87 and PCM-30 (both are trade names, manufactured by IKEGAI CORPORATION) and the like; open-roll kneaders such as Kneadex (trade name, manufactured by NIPPON COKE & ENGINEERING CO., LTD.) and the like.

Examples of the grinder include Counter Jet Mill AFG (trade name, manufactured by Hosokawa Micron Corporation) for grinding by using supersonic speed jet airflow and the like. Examples of a classifier include rotary classifier TSP separator (trade name, manufactured by Hosokawa Micron Corporation) and the like.

### (2) Preparation of Resin Fine Particles (P2)

Examples of a method for preparing the resin fine particles include a method of emulsion-dispersing a resin used as a resin fine particle raw material by using a homogenizer or the like, and a method of polymerizing a monomer by a method of emulsion-polymerization, soap-free emulsion polymerization, or the like. The resin fine particles are prepared as an emulsion having a solid content of 30% by weight (moisture content of 70% by weight).

The resin fine particles (primary particles) are desired to have a volume-average particle diameter which is sufficiently smaller than the average particle diameter of the core toner particles 101, and is preferably 0.05 μm or more and 1 μm or less. The volume-average particle diameter of the resin fine particles (primary particles) is more preferably 0.1 μm or more and 0.2 μm or less. When the volume-average particle diameter of the resin fine particles (primary particles) is 0.05 μm or more and 1 μm or less, the coating layer 102 (resin coating layer) having a preferred thickness can be formed on the surfaces of the core toner particles 101. Therefore, the capsule toner 100 produced by the method according to the embodiment can be easily caught by a cleaning blade during cleaning. This can improve the cleaning properties of the capsule toner 100.

In addition, the softening temperature of the rein used as the resin fine particle raw material is preferably higher than the glass transition point of the binder resin contained in the core toner particles 101 and is preferably 60° C. or more. Thus, the capsule toner 100 produced by the method according to the embodiment can be avoided from being fused during storage. Therefore, the storage stability of the capsule toner 100 can be improved.

### (3) Formation of Composite Particles (P3)

In formation of composite particles (P3), the composite particles are formed by coating the surfaces of the core toner particles 101 with the resin fine particles. An example of a method which can be used as a method for forming the composite particles includes introducing the core toner particles 101 and the resin fine particle emulsion in a Henschel mixer vacuum-drying system (trade name: FM20C, manufactured by NIPPON COKE & ENGINEERING CO., LTD) and decreasing the pressure in the mixer tank while stirring with stirring blades at a tip peripheral speed of 10 to 30 m/s. The composite particles dried to a moisture content of less than 1% by weight can be produced by mixing and drying under reduced pressure. The mixing ratio of the core toner particles 101 to the resin fine particles is preferably a mixing ratio such that the surfaces of the core toner particles 101 can be completely and thinly coated with the resin fine particles. With respect to the mixing ratio, 100 parts by weight of the core toner particles is mixed with the resin fine particles at a ratio of 5 parts by weight to 15 parts by weight. When the mixing ratio of the resin fine particles is less than 5 parts by weight, it is difficult to sufficiently coat the core toner particles 101, thereby causing the unsatisfactory storage stability. The mixing ratio exceeding 15 parts by weight causes difficulty in forming the coating layer 102 as a thin film due to the excessive coating amount, thereby degrading the low-temperature fixing properties.

### (4) Formation of Capsule Particles (P4)

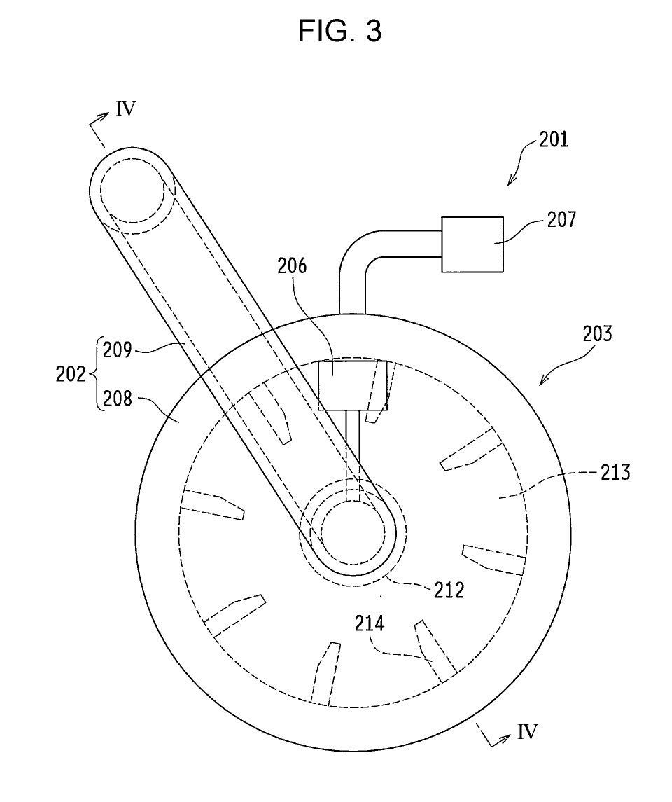

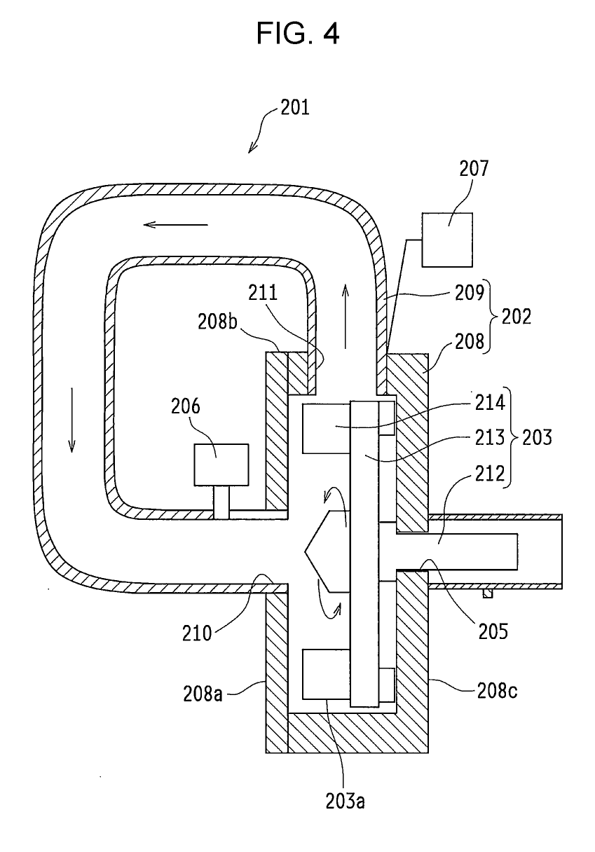

In formation of capsule particles (P4), a film of the resin fine particles is formed on the surfaces of the core toner particles 101 by applying mechanical impact force to the composite particles, thereby forming capsule particles. FIG. 3 is a front view showing the schematic configuration of an apparatus 201 for producing the capsule toner 100 used in the method for producing the capsule toner 100 according to the embodiment of the present disclosure. FIG. 4 is a schematic sectional view of the production apparatus 201 shown in FIG. 3 as viewed along section line IV-IV. In the formation of capsule particles (P4), for example, using the apparatus 201 for producing the capsule toner 100 shown in FIG. 3, the coating layer 102 (resin coating layer) is formed on the core toner particles 101 by the impact force generated by a synergetic effect of circulation and stirring of the composite particles produced in the formation of composite particles (P3) using the apparatus 201 for producing the capsule toner 100. The apparatus 201 for producing the capsule toner 100 is a rotary stirring apparatus and includes a powder flow passage 202, a rotary stirring unit 203 (rotary stirring part), a jacket for temperature control (not shown), a powder inlet part 206, and a powder recovery part 207. The rotary stirring unit 203 and the powder flow passage 202 constitute a circulation unit.

The powder flow passage 202 includes a stirring part 208 and a powder flow part 209. The stirring part 208 is a container-like member with a cylindrical shape having an inner space. The stirring part 208 serving as a rotary stirring chamber has openings 210 and 211 formed therein. The opening 210 is formed substantially at the central portion of the surface 208a on one of the sides in the axial direction of the stirring part 208 so as to pass through, in the thickness direction, the side wall containing the surface 208a of the stirring part 208. The opening 211 is formed in the side surface 208b perpendicular to the surface 208a on one of the sides in the axial direction of the stirring part 208 so as to pass through, in the thickness direction, the side wall containing the side surface 208b of the stirring part 208. The powder flow part 209 serving as a circulation pipe is connected to the opening 210 at one of the ends and is connected to the opening 211 at the other end. Therefore, the inner space of the stirring part 208 is communicated with the inner space of the powder flow part 209, forming the powder flow passage 202. The composite particles and gas are passed through the powder flow passage 202. The powder flow passage 202 is provided so that the powder flow direction, which is the flow direction of the composite particles, becomes unvariable.

The rotary stirring unit 203 includes a rotary shaft member 212, a disk-shaped rotary table 213, and plural stirring blades 214. The rotary shaft member 212 has an axis line coinciding with the axis line of the stirring part 208 and is provided so as to pass through a through hole 205, which is formed in the surface 208c on the other side in the axial direction of the stirring part 208 so as to pass through, in the thickness direction, the side wall containing the surface 208c. The rotary shaft member 212 is a columnar rod-shaped member which rotates around the axis line by a motor not shown in the drawings. The rotary table 213 is a disk-shaped member which is supported by the rotary shaft member 212 so that the axis line thereof coincides with the axis line of the rotary shaft member 212 and which rotates with rotation of the rotary shaft member 212. The plural stirring blades 214 are supported by the peripheral portion of the rotary table 213 and rotates with rotation of the rotary table 213.

In the formation of capsule particles (P4), the peripheral speed at the outermost periphery of the rotary stirring unit 203 is preferably set to 30 m/sec or more and more preferably set to 50 m/sec or more. The “outermost periphery” of the rotary stirring unit 203 is a portion 203a of the rotary stirring unit 203 at the longest distance from the axis line of the rotary shaft member 212 in the direction perpendicular to the direction in which the rotary shaft member 212 of the rotary stirring unit 203 extends. When, during rotation, the peripheral speed at the outermost periphery of the rotary stirring unit 203 is set to 30 m/sec or more, the composite particles can be dispersed in an airflow circulating at a flow rate of 30 m/sec or more in the annular flow passage (powder flow passage 202). Therefore, the composite particles can be isolatedly flowed. When the peripheral speed of the outermost periphery is less than 30 m/sec, it is difficult to isolatedly flow the composite particles, thereby causing difficulty in uniformly coating the core toner particles 101 with the resin film.

The jacket for temperature control not shown in the drawings and serving as a temperature control unit is provided on at least a portion of the outside of the powder flow passage 202 and controls the inside of the powder flow passage 202 and the rotary stirring unit 203 to a predetermined temperature by passing a cooling medium or heating medium through the space in the jacket. Thus, the temperatures of the inside of the powder flow passage and of the outside of the rotary stirring unit can be controlled to be equivalent or lower than a temperature which causes no softening deformation of the core toner particles 101 and of the resin fine particles.

### (5) External Addition (P5)

In external addition (P5), an external additive is adhered to the surfaces of the capsule toner particles by mixing the capsule toner particles with the external additive. Usable examples of the external additive include silica fine particles hydrophobized with a silane coupling agent and having a primary particle diameter of 7 nm to 20 nm, and the like.

A known mixer can be used as the mixer, and examples thereof include a Henschel mixer (trade name, manufactured by NIPPON COKE & ENGINEERING CO., LTD.), Super mixer (trade name, manufactured by KAWATA MFG. CO., LTD.), and the like.

### EXAMPLES

Embodiments of the present disclosure are specifically described by giving examples and comparative examples below.

### [Glass Transition Point (Tg) of Binder Resin/Core Toner Particle/Resin Fine Particle]

A DSC (Differential Scanning Calorimetry) curve is measured by heating 1 g of a sample at a heating rate per minute of 10° C. using a differential scanning calorimeter (trade name: DSC220, manufactured by Seiko Instruments Inc.) according to Japanese Industrial Standards (JIS) K7121-1987. The glass transition point (Tg) is determined from the intersection of a straight line, which is obtained by extending, to the lower temperature side, a base line on the higher temperature side of an endothermic peak corresponding to glass transition in the resultant DSC curve, and a tangent line drawn at a point with the maximum gradient of the curve from the rising portion to the top of the peak.

### [Softening Point (Tm) of Binder Resin/Core Toner Particle/Resin Fine Particle]

By using a flow characteristic evaluation apparatus (trade name: Flow Tester CFT-100C, manufactured by Shimadzu Corporation), 1 g of sample is heated at a heating rate per minute of 6° C. and flowed out from a die (nozzle pore diameter: 1 mm, length: 1 mm) by applying a load of 20 kgf/cm² (9.8×105 Pa). The temperature when the sample is started to be flowed out is referred to as the “outflow start temperature (Tfb)”, and the temperature when a half amount of the sample is flowed out is referred to as the “softening point (Tm)”.

### [Volume-Average Particle Diameter of Core Toner Particle/Capsule Toner Particle]

To 50 mL of an electrolyte (trade name: ISOTON-II, manufactured by Beckman Coulter Co., Ltd.), 20 mg of a sample and 1 mL of sodium alkyl ether sulfate are added and then dispersed for 3 minutes at a frequency of 20 kHz by using an ultrasonic disperser (trade name: desktop dual-frequency ultrasonic cleaner VS-D100, manufactured by As One Co., Ltd.), thereby preparing a sample for measurement. The resultant sample for measurement is measured by using a particle size distribution analyzer (trade name: Multisizer 3, manufactured by Beckman Coulter Co., Ltd.) under the conditions including an aperture diameter of 100 m and a number of particles measured of 50,000 counts, and the volume-average particle diameter is determined from a volume particle size distribution of the sample particles.

### [Volume-Average Particle Diameter of Resin Fine Particle]

The volume-average particle diameter of the resin fine particles is measured by two times of measurement using a dynamic light-scattering particle size distribution analyzer (trade name: Nanotrac, manufactured by Nikkiso Co., Ltd.) and determining an average value. The measurement conditions include a measurement time of 30 seconds, a sample particle refractive index of 1.49, a dispersion medium of water, and a dispersion medium refractive index of 1.33. The volume particle size distribution of the sample for measurement is measured, and, from the measurement results, the particle diameter at a cumulative volume of 50% from the small particle diameter side in the cumulative volume distribution is calculated as the volume-average particle diameter (m) of the resin fine particles.

### [Molecular Weight Mw of Resin Fine Particle]

An emulsion of the resin fine particles is freeze-dried by using a freeze dryer (trade name: compact freeze dryer FDS model, manufactured by Tokyo Rikakikai Co., Ltd.), and then the dried resin fine particles are dissolved in tetrahydrofuran (THF) so that the concentration is 0.25% by weight. Then, 200 μL of the sample is injected into a GPC apparatus (trade name: HLC-8220 GPC, manufactured by Tosoh Corporation), and a molecular weight distribution curve at a temperature of 40° C. is determined. The weight-average molecular weight Mw is determined from the obtained molecular weight distribution curve. A molecular weight calibration curve is formed by using standard polystyrene.

### Example 1

### (1) Formation of Core Toner Particles (P1)

To a reactor of 5 L maintained at an inner temperature of 180° C. and an inner pressure of 6 kg/cm², 20 parts by weight of a xylene solution, prepared by uniformly dissolving 1.5 parts by weight of di-tert-butyl peroxide in a solution containing 74 parts by weight of styrene, 26 parts by weight of n-butyl acrylate, and 80 parts by weight of a xylene solvent, is continuously supplied at 750 mL/hour and polymerized to prepare a solution of a styrene-acrylic resin. Then, the solvent is distilled off by flashing in a vessel at 90° C. and 10 mmHg, and then the residue is roughly ground by using a rough grinder to produce 1-mm chips of styrene-acrylic resin R-1 (refer to Table 1). Then, 5 parts by weight of carbon black (trade name: MA-100, manufactured by Mitsubishi Chemical Co., Ltd.) and 4 parts by weight of a release agent (trade name: Fischer-Tropsch wax, manufactured by Nippon Seiro Co., Ltd., melting point: 95° C.) are weighed relative to 100 parts by weight of the resultant styrene-acrylic resin and are placed in a Henschel mixer (trade name: FM20C, manufactured by Nippon Coke & Engineering Co., Ltd.), followed by stirring and mixing for 5 minutes at a tip peripheral speed of 40 m/sec of stirring blades. Then, the resultant mixture is melt-kneaded by using a twin-screw extruder (trade name: PCM-30, manufactured Ikegai Corporation), producing a melt-kneaded product. The resultant melt-kneaded product is cooled by a cooling belt, roughly ground by a speed mill having a 2-mm screen, and then finely ground and classified by using a counter jet mill AFG (trade name, manufactured by Hosokawa Micron Corporation) and a rotary classifier TSP separator (trade name, manufactured by Hosokawa Micron Corporation), thereby producing core toner particles C-1 having a volume-average particle diameter of 6.7 μm, a glass transition point of 51° C., and a softening point of 120° C. (refer to FIG. 2).

In addition, styrene-acrylic resins R-2 to R-6 shown in Table 1 are produced by changing the mixing ratio of styrene with n-butyl acrylate.

TABLE 1
Table 1 Styrene-acrylic resin R-1 to R-6

| | Glass transition point (Tg) | Softening point (Tm) |
|---|---|---|
| No. | ° C. | ° C. |
| R-1 | 53 | 122 |
| R-2 | 42 | 113 |
| R-3 | 60 | 135 |
| R-4 | 62 | 140 |
| R-5 | 40 | 110 |
| R-6 | 63 | 143 |

Further, core toner particles C-2 to C-10 shown in Table 2 are produced by the same method as for forming the core toner particles described above except that the type of the styrene-acrylic resin and the amount of the release agent added are changed.

TABLE 2
Table 2 Core toner particle C-1 to C-10

| | | | Glass transition | Softening point |
|---|---|---|---|---|
| | Styrene- | Amount of wax | point (Tg) | (Tm) |
| No. | acrylic resin | added | ° C. | ° C. |
| C-1 | R-1 | 4 | 51 | 120 |
| C-2 | R-2 | 4 | 41 | 111 |
| C-3 | R-3 | 4 | 58 | 134 |
| C-4 | R-4 | 4 | 59 | 139 |
| C-5 | R-1 | 5.9 | 49 | 118 |
| C-6 | | 2.1 | 53 | 122 |
| C-7 | R-5 | 4 | 39 | 109 |
| C-8 | R-6 | 4 | 61 | 141 |
| C-9 | R-1 | 1.9 | 53 | 123 |
| C-10 | | 6.1 | 49 | 117 |

### (2) Preparation of Resin Fine Particles (P2)

In a reactor provided with a stirring-heating device, a thermometer, a nitrogen inlet tube, and a condenser, 168 parts by weight of deionized water is added and heated to 80° C. To the reactor, a monomer mixed solution (pre-emulsion), which contains 252 parts by weight of deionized water, 65 parts by weight of styrene, 27 parts by weight of n-butyl acrylate, and 8 parts by weight of acrylic acid, and 56 parts by weight of an aqueous initiator solution, which contains 1 parts by weight of ammonium peroxydisulfate, 0.2 parts by weight of n-dodecyl mercaptan, and 62 parts by weight of deionized water, are simultaneously added dropwise over 110 minutes. After further stirring for 60 minutes, reaction is terminated to produce a substantially monodisperse emulsion (solid content of 30% by weight) of resin fine particles S-1 having a glass transition point of 80° C., a softening point of 145° C., a weight-average molecular weight (Mw) of 310,000, and a particle diameter of 0.143 μm.

In addition, emulsions (solid content of 30% by weight) of resin fine particle S-2 to S-17 are produced by changing the monomer types and adding amounts in the method for forming the resin fine particles S-1. Table 3 shows the physical properties of the resin fine particles S-1 to S-17.

TABLE 3
Table 3 Resin fine particle S-1 to S-17

| | Molecular | Glass transition | Softening point | Volume-average |
|---|---|---|---|---|
| | weight Mw | point (Tg) | (Tm) | particle |
| No. | (×1000) | ° C. | ° C. | diameter μm |
| S-1 | 310 | 80 | 145 | 0.143 |
| S-2 | 232 | 109 | 158 | 0.151 |
| S-3 | 130 | 105 | 148 | 0.142 |
| S-4 | 101 | 103 | 150 | 0.142 |
| S-5 | 270 | 108 | 169 | 0.145 |
| S-6 | 280 | 62 | 111 | 0.14 |
| S-7 | 448 | 90 | 149 | 0.147 |
| S-8 | 318 | 82 | 146 | 0.198 |
| S-9 | 311 | 80 | 145 | 0.101 |
| S-10 | 10 | 70 | 122 | 0.14 |
| S-11 | 99 | 102 | 146 | 0.138 |
| S-12 | 451 | 96 | 161 | 0.14 |
| S-13 | 257 | 59 | 108 | 0.146 |
| S-14 | 350 | 111 | 162 | 0.149 |
| S-15 | 365 | 122 | 171 | 0.151 |
| S-16 | 308 | 79 | 147 | 0.098 |
| S-17 | 321 | 83 | 148 | 0.202 |

### (3) Formation of Composite Particles (P3)

In a Henschel mixer vacuum drying system (trade name: FM20C, manufactured by Nippon Coke & Engineering Co., Ltd.), 100 parts by weight of the core toner particles C-1 and 7 parts by weight of the resin fine particles S-1 (in an emulsion state, 23 parts by weight relative to 100 parts by weight of core particles) are placed. Then, the vacuum degree in the mixer tank is reduced to 0.01 MPa at the same time as the start of stirring and mixing at a tip peripheral speed of 15 mm/sec of stirring blades. Stirring and mixing for 10 minutes under reduced pressure produces composite particles including the resin fine particles S-1 uniformly adhered to the surfaces of the core particles C-1. The moisture content of the composite particles is 0.1% by weight.

### (4) Formation of Capsule Particles (P4)

The composite particles are placed in a hybridization system (trade name: NHS-3 model, manufactured by Nara Machinery Co., Ltd.) according to the apparatus shown in FIG. 3, and stirred and mixed for 10 minutes at the peripheral speed set to 50 m/s at the outermost periphery of a rotary stirring unit to form a film of the resin fine particles S-1 on the surface of the core toner particles C-1, producing a capsule toner.

### (5) External Addition (P5)

In a Henschel mixer (trade name: FM20C, manufactured by Nippon Coke & Engineering Co., Ltd.), 100 parts by weight of the capsule toner produced in formation of the capsule particles (P4) and 2 parts by weight of hydrophobic silica fine particles containing primary particles with an average particle diameter of 12 nm and serving as an external additive are introduced, and stirred and mixed for 3 minutes at the peripheral speed of 30 m/sec in a rotary shaft member, thereby producing a capsule toner T-1 of Example 1 (refer to FIG. 4).

### Examples 2 to 16

Capsule toners T-2 to T-11 of Examples 2 to 11 are produced by the same method as in Example 1 except that the type and amount of the resin fine particles added are changed as shown in Table 4.

Also, capsule toners T-12 to T-16 of Examples 12 to 16 are produced by the same method as in Example 1 except that the type the core toner particles is changed as shown in Table 4.

TABLE 4
Table 4 Capsule toner T-1 to T-16 (Example)

| | | | | Amount of | Formation of |
|---|---|---|---|---|---|
| | Cap- | Core | Resin | resin fine | capsule particle |
| | sule | toner | fine | particle added | Stirring |
| | toner | particle | particle | parts by weight | time min |
| Example 1 | T-1 | C-1 | S-1 | 7 | 10 |
| Example 2 | T-2 | | S-2 | | |
| Example 3 | T-3 | | S-3 | | |
| Example 4 | T-4 | | S-4 | | |
| Example 5 | T-5 | | S-5 | | |
| Example 6 | T-6 | | S-6 | | |
| Example 7 | T-7 | | S-7 | | |
| Example 8 | T-8 | | S-8 | | |
| Example 9 | T-9 | | S-9 | | |
| Example 10 | T-10 | | S-1 | 5 | |
| Example 11 | T-11 | | | 15 | |
| Example 12 | T-12 | C-2 | | 7 | |
| Example 13 | T-13 | C-3 | | | |
| Example 14 | T-14 | C-4 | | | |
| Example 15 | T-15 | C-5 | | | |
| Example 16 | T-16 | C-6 | | | |

### Comparative Examples 1 to 16

Capsule toners T-17 to T-26 of Comparative Examples 1 to 10 are produced by the same method as in Example 1 except that the type and amount of the resin fine particles added are changed as shown in Table 5.

Also, capsule toners T-27 to T-30 of Comparative Examples 11 to 14 are produced by the same method as in Example 1 except that the type the core toner particles is changed as shown in Table 5.

Further, capsule toners T-31 and T-32 of Comparative Examples 15 and 16 are produced by the same method as in Example 1 except that the stirring-mixing time in the formation of the capsule particles (P4) is changed as shown in Table 5.

TABLE 5
Table 5 Capsule toner T-17 to T-32 (Comparative Example)

| | | | | Amount of | Formation of |
|---|---|---|---|---|---|
| | Cap- | Core | Resin | resin fine | capsule particle |
| | sule | toner | fine | particle added | Stirring |
| | toner | particle | particle | parts by weight | time min |
| Comparative | T-17 | C-1 | S-10 | 7 | 10 |
| Example 1 | | | | | |
| Comparative | T-18 | | S-11 | | |
| Example 2 | | | | | |
| Comparative | T-19 | | S-12 | | |
| Example 3 | | | | | |
| Comparative | T-20 | | S-13 | | |
| Example 4 | | | | | |
| Comparative | T-21 | | S-14 | | |
| Example 5 | | | | | |
| Comparative | T-22 | | S-15 | | |
| Example 6 | | | | | |
| Comparative | T-23 | | S-16 | | |
| Example 7 | | | | | |
| Comparative | T-24 | | S-17 | | |
| Example 8 | | | | | |
| Comparative | T-25 | | S-1 | 4 | |
| Example 9 | | | | | |
| Comparative | T-26 | | | 16 | |
| Example 10 | | | | | |
| Comparative | T-27 | C-7 | | 7 | |
| Example 11 | | | | | |
| Comparative | T-28 | C-8 | | | |
| Example 12 | | | | | |
| Comparative | T-29 | C-9 | | | |
| Example 13 | | | | | |
| Comparative | T-30 | C-10 | | | |
| Example 14 | | | | | |
| Comparative | T-31 | C-1 | | | 5 |
| Example 15 | | | | | |
| Comparative | T-32 | | | | 15 |
| Example 16 | | | | | |

### <Evaluation Method>

The capsule toners produced in Examples 1 to 16 and Comparative Examples 1 to 16 are evaluated as follows.

### [Powder Flowability in Formation of Capsule Particles]

In the formation of the capsule particles (P4) using the hybridization system (trade name: NHS-3 model, manufactured by Nara Machinery Co., Ltd.), the current value in the apparatus is used as an index for powder flowability of the composite particles. In the formation of the capsule particles (P4) according to the embodiment, the current value exceeds a peak value within about 1 to 2 minutes after introduction of the composite particles, then gradually decreases, and reaches a saturation value. The powder flowability in the formation of the capsule particles (P4) is evaluated according to the following criteria.

A: The peak value is 70 A or more and the saturation value is 50 A or more

B: The peak value is 60 A or more and less than 70 A and the saturation value is 40 A or more and less than 50 A

C: The peak value is less than 60 A or the saturation value is less than 40 A

### [Uniformity of Coating Layer]

A cured product containing the capsule toner particles embedded in an epoxy resin curable at room temperature is cut at plural positions to form ultrathin sections (about 200 nm) by using a microtome having diamond teeth and then stained with ruthenium. The sections of the toner particles are enlarged 50,000 times and photographed by a transmission electron microscope (trade name: H-8100, manufactured by Hitachi, Ltd.). The film state of the coating surface is stained and clearly recognized, and thus can be discriminated from the core toner particles. Therefore, the thickness of the coating layer which coats the toner base particles is measured by using an image analysis software. The evaluation criteria for uniformity of the coating layer is as follows.

A: The core toner particles are uniformly coated with the coating layer having a thickness of less than 30 nm.

B: The thickness of the Coating layer is 30 nm or more and is nonuniform.

C: The core toner particles are exposed from the coating layer having a nonuniform thickness.

### [Moisture Content]

The moisture content of the composite particles containing the core toner particles and the resin fine particles is measured by using an infrared moisture meter (trade name: FD-720, manufactured by Kett Electric Laboratory). The moisture content is measured when a change in moisture for 30 seconds of 10 g of a measurement sample set on a sample dish is 0.05% or less at a drying temperature of 120° C.

### [Circularity]

The circularity of the capsule toner can be measured by, for example, using a flow-type particle image analyzer “FPIA-3000” (manufactured by Malvern Instruments Ltd.) but the apparatus is not particularly limited as long as the measurement principle is the same. The apparatus has the measurement principle that a still image of particles in a dispersion medium is photographed by a CCD camera, and the circularity and the like are calculated from the image. A sample introduced from a chamber is sent to a flat-sheath flow cell and held by a sheath liquid to form a flat flow. A still image is photographed by the CCD camera under irradiation of the sample passing through the cell with strobe light. The contour of each of the particles is extracted by image processing of the photographed image, and the projection area S, peripheral length L, and the like of the particle image are measured. Based on these values, the equivalent circle diameter and circularity are calculated.

The equivalent circle diameter represents the diameter of a circle having the same area as the projection area of the particle image. The circularity is defined as a value obtained by dividing the peripheral length of the circle, determined from the equivalent circle diameter, by the peripheral length of the particle projection image, and is calculated by a formula below wherein S is the area of the circle determined from the equivalent circle diameter, and L is the peripheral length of the particle projection image.

Circularity=2×(π×S)^{1/2}/L

A sample is dispersed by using a particle sheath “PSE-900A” (manufactured by Malvern Instruments Ltd.) as the sheath liquid, an aqueous dispersion of 5% by weight of commercial household detergent as a dispersant, and an autosampler device as a disperser. The resultant dispersed sample is introduced in the flow-type particle image analyzer, and a total count of 10,000 capsule toner particles is measured in a HPF measurement mode. The average circularity of the capsule toner over the entire particle diameter range is determined with the binarization threshold value of 85% during particle analysis.

In order to avoid the occurrence of a cleaning defect described below, the average circularity is desirably not excessively high. Also, with the excessively low average circularity, the uniform resin coating layer may not be formed on the surfaces of the core toner particles. Therefore, the evaluation criteria for average circularity are as follows.

A: Average circularity of 0.950 or more and less than 0.975

C: Average circularity of less than 0.950 or 0.975 or more

### [Number Ratio of Remaining Shells]

The same flow-type particle image analyzer “FPIA-3000” (manufactured by Malvern Instruments Ltd.) as in measurement of circularity is used for the number ratio of remaining shells.

A total count of 10,000 capsule toner particles is measured in a HPF measurement mode, and when particles having an equivalent circle diameter value of less than 1 μm are specified as remaining shells, the number ratio is determined. The evaluation criteria are as follows.

A: The number ratio of remaining shells is less than 5.0%

B: The number ratio of remaining shells is 5.0% or more and less than 15.0%

C: The number ratio of remaining shells is 15.0% or more

Further, a two-component developer is prepared by using the capsule toner of each of the examples and comparative examples and is evaluated as follows. The two-component developer is prepared by mixing a ferrite carrier having a volume-average particle diameter of 50 μm with the capsule toner so that the toner concentration is 7%.

### [Strength of Coating Layer]

In a glass-made screw tube of 20 cc, 25 g of a carrier having a diameter of 100 μm and 5 g of the capsule toner are placed and mixed for 30 minutes by using a shaker at a frequency of 35 Hz. Then, a developer (mixture of the carrier and the toner) is washed and filtered to remove only the carrier. The particle size distribution of a filtrate after removal of the carrier is measured (“FPIA-3000” (manufactured by Malvern Instruments Ltd.)), and a difference from the initial toner particle diameter is confirmed.

The film strength is evaluated by an increase in amount of the fine particles having an equivalent circle diameter of less than 1 μm compared with the initial tone particle size distribution.

A: The increase rate of fine particles is less than 5.0%

B: The increase rate of fine particles is 5.0% or more and less than 8.0%

C: The increase rate of fine particles is 8.0% or more

### [Cleaning Properties]

A developing unit of a commercial copying machine (trade name: MX-5111FN, manufactured by Sharp Corporation) having a two-component developing device is filled with the two-component developer, and an original with a printing rate of 5% is continuously printed on 10,000 sheets of A4 recording paper. Then, the presence of image defect due to cleaning defect is confirmed.

A: No occurrence of cleaning defect

C: Occurrence of cleaning defect

### [Fixing Properties]

The developing unit of the commercial copying machine is filled with the two-component developer, and a sample image containing a rectangular solid image of 20 mm in length and 50 mm in width is formed as an unfixed image on a recording medium (trade name: PPC paper SF-4AM3, manufactured by Sharp Corporation). In this case, the amount of the toner deposited on a solid image portion is adjusted to be 0.5 mg/cm². Next, a fixed image is formed by using an external fixing device using a fixing part of a composite machine. The fixing process speed is set to 250 mm/sec, and a temperature region which causes neither low-temperature offset nor high-temperature offset is measured by increasing the temperature of a fixing belt from 150° C. to 220° C. at an interval of 10° C., and the temperature region is considered as a non-offset region. The high-temperature offset and low-temperature offset represent that the toner is not fixed to the recording paper during fixing and remains adhered to the fixing belt, and the toner is again adhered to the recording paper after the fixing belt makes one round.

Further, the surface of an image on an image sample fixed at a fixing belt temperature of 150° C. is abraded by three reciprocations a rubber sand eraser with a load of 1 kg thereon in a Gakushin-type fastness tester. In addition, the optical reflectance density (image density) is measured by a reflectance densitometer (manufactured by Macbeth Corporation) before and after abrasion, and the fixing rate (%) is calculated by the following formula.

Fixing ratio (%)=[(image density after abrasion)/(image density before abrasion)]×100

The fixing properties are evaluated from the results of the fixing non-offset region and fixing rate according to the following criteria.

A: No offset occurs on the image sample at 150° C. to 220° C., with a fixing rate of 70% or more

B: No offset occurs on the image sample at 150° C. to 220° C., with a fixing rate of less than 70% or more

C: Offset occurs on the image sample at 150° C. to 220° C.

### [Storage Stability]

In a plastic vessel with a volume of 250 mL, 100 g of the capsule toner is closed and maintained for 48 hours under the condition of a temperature of 60° C. Then, the capsule toner is taken out and sieved with a #100 mesh (nominal size of 150 μm). The weight of the capsule toner remaining on the sieve (mesh-up amount) is measured, and the residual amount (ratio by weight) is determined as a ratio to the total weight of the capsule toner, which has been previously measured. The storage stability is evaluated according to criteria below. The lower value obtained indicates the good storage stability with no occurrence of blocking of the capsule toner. The evaluation criteria for the storage stability are as follows.

A: Residual amount of 0% or more and less than 1.0%

B: Residual amount of 1.0% or more and less than 3.0%

C: Residual amount of 3.0% or more

### [Stress Resistance in Developing Tank]

The developing unit of the commercial copying machine described above is filled with the two-component developer, and an original with a printing rate of 25% is continuously printed on 1,000 sheets of A4 recording paper. Next, a black solid image is output on one sheet. This cycle is repeated to continuously print an original with a printing rate of 25% on a total of 100,000 sheets, and the image quality of the black solid image is confirmed.

When the continuous output of the image with a high printing rate as described above causes the fusion of the toner and the resin fine particles on a developing roller, the resistance of the developing roller is increased. Thus, the electric field between the developing roller and the photoreceptor drum becomes unstable, thereby causing image unevenness on the black solid image.

Therefore, after printing on 100,000 sheets, the developer on the surface of the developing roller is removed by an air blow, and the surface state of the developing roller is visually observed. Further, the presence of an image defect on the black solid image due to deterioration of surface properties of the developing roller is confirmed and evaluated according to the following criteria.

A: There is glossiness on the surface of the developing roller and no image defect due to 100,000-sheet printing.

B: There is no glossiness on the surface of the developing roller and no image defect due to 100,000-sheet printing.

C: There is no glossiness on the surface of the developing roller and the occurrence of image defect due to 100,000-sheet printing.

### [Overall Evaluation]

Based on the evaluation results of the cleaning properties, fixing properties, storage stability, and stress resistance in the developing tank, overall evaluation of the capsule toner according to the embodiment is made. The evaluation criteria are as follows.

A: All evaluation results are A or good.

B: Any of the evaluation results is B but not C.

C: Any of the evaluation results is C.

Table 6 shows a list of physical property confirmation of Examples 1 to 16 and Comparative Examples 1 to 16, and Table 7 shows the overall evaluation results of the toner characteristics.

TABLE 6
Table 6 Confirmation of physical properties of capsule toner

| | Powder | Uniformi- | | Number | Strength |
|---|---|---|---|---|---|
| | flowability in | ty of | | ratio of | of |
| | formation of | coating | Circu- | remaining | coating |
| | capsule particle | layer | larity | shells | layer |
| Example 1 | A | A | A | A | A |
| Example 2 | A | A | A | A | A |
| Example 3 | A | A | A | A | A |
| Example 4 | B | B | A | A | B |
| Example 5 | A | A | A | A | A |
| Example 6 | A | A | A | A | A |
| Example 7 | A | A | A | A | A |
| Example 8 | A | B | A | B | A |
| Example 9 | A | A | A | B | A |
| Example 10 | A | A | A | A | A |
| Example 11 | A | B | A | B | A |
| Example 12 | A | A | A | B | A |
| Example 13 | A | A | A | A | A |
| Example 14 | A | A | A | A | A |
| Example 15 | B | B | A | B | A |
| Example 16 | A | A | A | A | A |
| Comparative | C | C | C | C | C |
| Example 1 | | | | | |
| Comparative | C | B | A | B | B |
| Example 2 | | | | | |
| Comparative | A | B | A | C | A |
| Example 3 | | | | | |
| Comparative | A | A | A | A | A |
| Example 4 | | | | | |
| Comparative | A | A | A | A | A |
| Example 5 | | | | | |
| Comparative | A | A | A | A | A |
| Example 6 | | | | | |
| Comparative | B | C | A | C | A |
| Example 7 | | | | | |
| Comparative | B | B | A | B | A |
| Example 8 | | | | | |
| Comparative | B | C | A | A | A |
| Example 9 | | | | | |
| Comparative | A | B | A | B | A |
| Example 10 | | | | | |
| Comparative | B | B | A | B | A |
| Example 11 | | | | | |
| Comparative | A | A | A | A | A |
| Example 12 | | | | | |
| Comparative | A | A | A | A | A |
| Example 13 | | | | | |
| Comparative | B | C | A | B | A |
| Example 14 | | | | | |
| Comparative | A | B | C | B | A |
| Example 15 | | | | | |
| Comparative | A | A | C | A | A |
| Example 16 | | | | | |

TABLE 7
Table 7 Overall evaluation of toner characteristics

| | | | | Stress | |
|---|---|---|---|---|---|
| | | | | resistance | Overall |
| | Cleaning | Fixing | Storage | (in developing | evalu- |
| | properties | properties | stability | tank) | ation |
| Example 1 | A | A | A | A | A |
| Example 2 | A | A | A | A | A |
| Example 3 | A | A | A | A | A |
| Example 4 | A | A | A | A | A |
| Example 5 | A | A | A | A | A |
| Example 6 | A | A | A | A | A |
| Example 7 | A | A | A | A | A |
| Example 8 | A | A | A | A | A |
| Example 9 | A | A | A | A | A |
| Example 10 | A | A | A | A | A |
| Example 11 | A | A | A | A | A |
| Example 12 | A | A | A | A | A |
| Example 13 | A | A | A | A | A |
| Example 14 | A | A | A | A | A |
| Example 15 | A | A | A | A | A |
| Example 16 | A | A | A | A | A |
| Comparative | C | A | B | C | C |
| Example 1 | | | | | |
| Comparative | A | B | A | C | C |
| Example 2 | | | | | |
| Comparative | A | C | A | A | C |
| Example 3 | | | | | |
| Comparative | A | A | B | A | B |
| Example 4 | | | | | |
| Comparative | A | B | A | A | B |
| Example 5 | | | | | |
| Comparative | A | C | A | A | C |
| Example 6 | | | | | |
| Comparative | A | A | C | B | C |
| Example 7 | | | | | |
| Comparative | A | B | A | A | B |
| Example 8 | | | | | |
| Comparative | A | A | C | B | C |
| Example 9 | | | | | |
| Comparative | A | C | A | A | C |
| Example 10 | | | | | |
| Comparative | A | B | A | A | B |
| Example 11 | | | | | |
| Comparative | A | C | A | A | C |
| Example 12 | | | | | |
| Comparative | A | C | A | A | C |
| Example 13 | | | | | |
| Comparative | A | A | B | C | C |
| Example 14 | | | | | |
| Comparative | A | A | B | A | B |
| Example 15 | | | | | |
| Comparative | C | A | A | A | C |
| Example 16 | | | | | |

The toners of Examples 1 to 16 show the good evaluation results of all toner characteristics (cleaning properties, fixing properties, storage stability, and stress resistance in the developing tank).

Comparative Example 1 uses the resin fine particles S-10 having a low molecular weight and thus shows low powder flowability in the apparatus 201 for producing the capsule toner shown in FIGS. 3 and 4, thereby making the coating layer nonuniform and partially exposing the core toner particles. Further, many remaining shells occur. Therefore, the result of storage stability is poor. Also, deformation of the capsule toner is accelerated by mechanical treatment by rotation of the rotary stirring unit, thereby enhancing circularity. Thus, a cleaning defect occurs. In addition, the low molecular weight of the resin fine particles and weak strength of the coating layer result in an image defect in evaluation of stress resistance in the developing tank.

Also, Comparative Example 2 uses the resin fine particles S-11 having a low molecular weight and thus shows poor results of uniformity of the coating layer, amount of remaining shells, and strength of the coating layer. The core toner particles are not exposed, and thus the good result of storage stability is exhibited. However, in a fixing test, heat is not sufficiently transmitted to the toner, failing to obtain the fixing strength. Like in Comparative Example 1, the evaluation result of stress resistance in the developing tank is poor.

On the other hand, in Comparative Example 3, because of the high molecular weight and hardness of the resin fine particles S-12, the uniform coating film may not be formed by the impact force of the stirring part in formation of the capsule particles (P4). Therefore, in a fixing test, heat is not sufficiently transmitted to the toner, causing offset in the image sample at a fixing temperature of 150° C.

Comparative Example 4 shows the poor evaluation results of stress resistance in the developing tank and storage stability. This is considered to be due to the low glass transition point and low softening point of the resin fine particles S-13, although the uniform coating layer can be formed.

On the other hand, Comparative Example 5 shows the poor result of fixing properties. Although the uniform coating layer can be formed, heat is not sufficiently transmitted to the toner due to the high glass transition point and high softening point of the resin fine particles S-14, failing to obtain the fixing strength.

Like in Comparative Example 5, Comparative Example 6 shows the poor result of fixing properties. The high glass transition point and high softening point of the resin fine particles S-15 result in the occurrence of offset on the image sample at a fixing temperature of 150° C.

Comparative Example 7 shows the poor evaluation results of storage stability and stress resistance in the developing tank. This is considered to be due to the fact that a difference in specific gravity occurs between the core toner particles and the resin fine particles S-16 having a small volume-average particle diameter, and thus the resin fine particles are separated from the surfaces of the composite particles in formation of the capsule particles and are not adhered again, thereby forming the nonuniform coating layer. A large amount of remaining shells occurs and the exposed core toner particles are confirmed, thereby causing the poor storage stability. It is also considered that the coating layer has satisfactory strength due to the high molecular weight of the resin fine particles, but exposure of the core toner particles causes the poor evaluation result of stress resistance in the developing tank.

Comparative Example 8 shows the poor result of fixing properties. This is considered to be due to the fact that the uniform coating layer is not formed in formation of the capsule particles (P4) because of the large volume-average particle diameter and poor powder flowability of the resin fine particles S-16. Therefore, in a fixing test, heat is not sufficiently transmitted to the toner, failing to obtain the fixing strength.

Comparative Example 9 shows the poor evaluation results of storage stability and stress resistance in the developing tank. This is considered to be due to the fact that the core toner particles are not sufficiently coated because of the small amount of the resin fine particles S-1 added, and thus exposure is observed.

Comparative Example 10 shows the poor evaluation result of fixing properties. This is considered to be due the fact that the coating layer becomes excessive because of the large amount of the resin fine particles S-1 added, and, in a fixing test, heat is not sufficiently transmitted to the toner, thereby causing offset in the image sample at a fixing temperature of 150° C.

Comparative Example 11 shows the poor evaluation result of fixing properties. This is considered to be due the fact that flowability in formation of the capsule particle (P4) is degraded because of the low glass transition point and softening point of the core toner particles C-7, thereby failing to form the uniform coating layer.

Comparative Example 12 shows the high powder flowability and good film quality in formation of the capsule particles (P4), but shows the poor result of fixing properties. It is considered that in a fixing test, heat is not sufficiently transmitted to the inside of the toner due to the high glass transition point and high softening point of the core toner particles C-8, thereby causing offset.

Like in Comparative Example 12, Comparative Example 13 shows good film quality but shows the poor result of fixing properties. This is due to the fact that in a fixing test, the wax breeding effect is not obtained because of the small amount of the wax added to the core toner particles C-9, thereby causing high-temperature offset.

Comparative Example 14 shows the poor evaluation results of stress resistance in the developing tank and poor storage stability. This is due to the fact that powder flowability in formation of the capsule particle (P4) is degraded because of the large amount of the core toner particles C-10, thereby failing to form the uniform coating layer and causing exposure of the core toner particles.

Comparative Example 15 shows the poor result of storage stability. This is considered to be due to the fact that the uniform coating layer is not formed on the surfaces of the core toner particles because of the short stirring-mixing time in formation of the capsule particles (P4). Also, the measured value of circularity is as low as less than 0.950.

Comparative Example 16 shows the poor result of fixing properties. This is considered to be due to the fact that the circularity of the capsule toner is enhanced because of the long stirring-mixing time in formation of the capsule particles (P4), thereby causing unsatisfactory scraping-off of the toner with the cleaning blade.

### Embodiments of the Present Disclosure

The capsule toner 100 (toner for electrostatic latent image development) according to the embodiment contains the core toner particles 101 produced by the grinding method and further contains, on the surfaces of the core toner particles 101, the coating layer 102 (shell layer) which coats the core toner particles 101. The resin fine particles which form the coating layer 102 have a weight-average molecular weight (simply referred to as a “molecular weight” hereinafter) value within a range of Mw=100×1,000 to 450×1,000 measured by gel permeation chromatography (GPC).

According to the embodiment, the resin fine particles which form the coating layer 102 have a higher weight-average molecular weight Mw of 100×1,000 to 450×1,000 and higher hardness than usual. Therefore, in the apparatus 201 for producing the capsule toner 100, capsulation treatment can be performed by rotating the rotary stirring unit 203 (rotary stirring part) while maintaining the highly fluidized state. Thus, the resin fine particles can be uniformly dispersed on the surfaces of the core toner particles 101 by capsulation treatment in the highly fluidized state, and the coating layer 102 can be uniformly and thinly formed.

In addition, according to the embodiment, the resin fine particles have a higher molecular weight than usual, and thus the coating layer 102 with high mechanical strength can be formed on the surfaces of the core toner particles 101. Therefore, the capsule toner 100 having excellent stress resistance in the developing tank can be formed, and an image stable over a long period of time can be obtained.

Also, according to the embodiment, the coating layer 102 can be formed as a thin film on the surfaces of the core toner particles 101, and thus heat energy can be easily transmitted to the inside of the core toner particles 101 during fixing, thereby making it possible to form the capsule toner 100 having excellent low-temperature fixing performance. In addition, the surfaces of the core toner particles 101 can be uniformly coated with the resin fine particles, thereby making it possible to obtain the capsule toner 100 also having excellent storage stability.

In addition, the strength and heat resistance of the resin fine particles which form the coating layer 102 can be enhanced. Therefore, in the apparatus 201 for producing the capsule toner 100, formation of the uniform coating layer 102 on the surfaces of the core toner particles 101 can be easily realized while suppressing an increase in circularity of the capsule toner 100. Thus, the capsule toner 100 having excellent cleaning properties can be produced.

In addition, the resin fine particles which form the coating layer 102 have a glass transition point (Tg) within a range of 60° C. to 110° C. and a softening point (Tm) within a range of 110° C. to 170° C. Thus, it is possible to improve the stress resistance in the developing tank, storage stability, and low-temperature fixing properties of the capsule toner 100.

In addition, the resin fine particles which form the coating layer 102 have a volume-average particle diameter within a range of 0.10 μm to 0.20 μm. Therefore, the coating layer 102 having a suitable thickness can be formed on the surfaces of the core toner particles 101, and the cleaning properties of the capsule toner 100 can be improved.

Further, the adding amount of the resin fine particles which form the coating layer 102 is within a range of 5 parts by weight to 15 parts by weight relative to 100 parts by weight of the core toner particles. Therefore, the storage stability and low-temperature fixing properties of the capsule toner 100 can be improved.

Further, the core toner particles 101 have a glass transition point (Tg) within a range of 40° C. to 60° C. and a softening point (Tm) within a range of 110° C. to 140° C. Therefore, flowability of the core toner particles 101 can be improved. Thus, the uniform coating layer 102 can be formed, and the low-temperature fixing properties of the capsule toner 100 can be improved.

The core toner particles contain the release agent, and the content of the release agent in the core toner particles is within a range of 2.0 parts by weight to 6.0 parts by weight relative to 100 parts by weight of the base resin 100 of the core toner particles. This can decrease the occurrence of high-temperature offset during fixing of the capsule toner 100 and can avoid deterioration in flowability of the core toner particle 101.

An external additive including one or more types of inorganic particles containing at least silica is externally added. This can suppress a decrease in flowability and thus can produce the capsule toner 100 having more excellent cleaning properties.

The present disclosure is not limited to the embodiments described above and may be carried out in various embodiments. Therefore, the embodiments are merely illustrative in all respects and are not restrictively interpreted. The scope of the present disclosure is indicated by the claims and is not restricted by the description in the specification. Further, all changes and modifications which come within the range of equivalency of the claims are within the scope of the present disclosure.

The present disclosure contains subject matter related to that disclosed in Japanese Priority Patent Application JP 2018-076586 filed in the Japan Patent Office on Apr. 12, 2018 and Japanese Priority Patent Application JP 2019-020688 filed in the Japan Patent Office on Feb. 7, 2019, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A capsule toner comprising:
core toner particles; and
a coating layer that coats the core toner particles,
wherein resin fine particles that form the coating layer have a weight-average molecular weight value within a range of Mw=100×1,000 to 450×1,000 measured by gel permeation chromatography (GPC).

2. The capsule toner according to claim 1, wherein the resin fine particles that form the coating layer have a glass transition point (Tg) within a range of 60° C. to 110° C. and a softening point (Tm) within a range of 110° C. to 170° C.

3. The capsule toner according to claim 1, wherein the resin fine particles that form the coating layer have a volume-average particle diameter within a range of 0.10 μm to 0.20 μm.

4. The capsule toner according to claim 1, wherein the adding amount of the resin fine particles that form the coating layer is within a range of 5 parts by weight to 15 parts by weight relative to 100 parts by weight of the core toner particles.

5. The capsule toner according to claim 1, wherein the core toner particles have a glass transition point (Tg) within a range of 40° C. to 60° C. and a softening point (Tm) within a range of 110° C. to 140° C.

6. The capsule toner according to claim 1,
wherein the core toner particles contain a release agent; and
the content of the release agent in the core toner particles is within a range of 2.0 parts by weight to 6.0 parts by weight relative to 100 parts by weight of the base resin of the core toner particles.

7. The capsule toner according to claim 1, wherein an external additive including one or more types of inorganic particles containing at least silica is externally added.

8. A two-component developer comprising the capsule toner according to claim 1 and a carrier.

9. An image forming apparatus using the two-component developer according to claim 8.

10. A method for producing the capsule toner according to claim 1, the method comprising:
dispersing composite particles produced by mixing and drying, under reduced pressure, the core toner particles and an emulsion of the resin fine particles, that form the coating layer, in an air flow at a flow rate of 30 m/sec or more that circulates in an annular flow passage; and
mechanically treating the composite particles by a rotary stirring part provided in the middle of the flow passage.
